(19) United States
(12) Patent Application Publication
(10) Pub. No.: US 2024/0261744 A1
(43) Pub. Date: Aug. 8, 2024

(54) METHOD AND APPARATUS FOR MANUFACTURING POSITIVE ELECTRODE FOR NON-AQUEOUS SECONDARY BATTERY

(71) Applicant: HONDA MOTOR CO., LTD., Tokyo (JP)

(72) Inventor: Yusuke YOSHIZAKI, Saitama (JP)

(21) Appl. No.: 18/424,892

(22) Filed: Jan. 29, 2024

(30) Foreign Application Priority Data
Feb. 3, 2023 (JP) 2023-015231

(51) Int. Cl. B01F 27/90; B01F 27/808; B01F 101/59; H01M 4/02; H01M 4/1391

(52) U.S. Cl. CPC B01F 27/90; B01F 27/808; H01M 4/1391; B01F 2101/59; H01M 2004/028

(57) ABSTRACT

Provided is a method for manufacturing a positive electrode for a non-aqueous secondary battery, the method making it possible to uniformly mix a positive electrode material containing a solid electrolyte. A method for manufacturing a positive electrode for a non-aqueous secondary battery includes successive steps of: loading a solid electrolyte into a mixer container; loading a positive electrode active material such that the positive electrode active material covers the solid electrolyte loaded in the step of loading the solid electrolyte; and mixing the solid electrolyte and the positive electrode active material.

### This application is based on and claims the benefit of priority from Japanese Patent Application No. 2023-015231, filed on 3 Feb. 2023, the content of which is incorporated herein by reference.

### BACKGROUND OF THE INVENTION

### Field of the Invention

The present invention relates to a method for manufacturing a positive electrode for a non-aqueous secondary battery and an apparatus for manufacturing such a positive electrode.

### Related Art

In recent years, research and development of secondary batteries that contribute to energy efficiency has been carried out in order to ensure many people have access to affordable, reliable, sustainable, and advanced energy.

As such a secondary battery, a non-aqueous secondary battery such as a lithium ion secondary battery in which a non-aqueous electrolytic solution and a separator are disposed between a positive electrode and a negative electrode is known. A positive electrode for a non-aqueous secondary battery includes a positive electrode active material and a current collector. Specifically, the positive electrode for a non-aqueous secondary battery is produced by forming, on the current collector, a positive electrode active material layer by way of application of a paste or a slurry that has been prepared by kneading a material containing a positive electrode active material (for example, see Japanese Unexamined Patent Application, Publication No. 2016-72200).

Patent Document 1: Japanese Unexamined Patent Application, Publication No. 2016-72200

### SUMMARY OF THE INVENTION

Japanese Unexamined Patent Application, Publication No. 2016-72200 describes a method for defoaming an electrode paste containing an electrode active material and a dispersion medium. Incidentally, it is preferable that a positive electrode active material layer contains a solid electrolyte mixed therein in order to improve the ion conductivity of the positive electrode. However, there is a disadvantage that it is difficult to knead a solid electrolyte with other materials to a sufficient extent because the solid electrolyte has a relatively small particle diameter, a low surface viscosity, and a small specific gravity. For example, when a paste or a slurry is prepared by simply kneading a solid electrolyte and a material containing a positive electrode active material, particles of the solid electrolyte rise to be scattered, and adhere to the inner wall of the container, thereby preventing uniform kneading. In addition, the resultant paste or slurry has a mixing ratio different from the mixing ratio between the materials loaded, which constitutes another disadvantage.

The present invention has been made in view of the above disadvantages, and an object of the present invention is to provide a method for manufacturing a positive electrode for a non-aqueous secondary battery, the method making it possible to uniformly mix a positive electrode material containing a solid electrolyte.

A first aspect of the present invention is directed to a method for manufacturing a positive electrode for a non-aqueous secondary battery. The method includes successive steps of: loading a solid electrolyte into a mixer container;

loading a positive electrode active material such that the positive electrode active material covers the solid electrolyte loaded in the step of loading the solid electrolyte; and mixing the solid electrolyte and the positive electrode active material.

The method according to the first aspect of the present invention makes it possible to uniformly mix a positive electrode material containing a solid electrolyte.

A second aspect of the present invention is an embodiment of the first aspect. In the method for manufacturing a positive electrode for a non-aqueous secondary battery according to the second aspect, the step of loading the solid electrolyte includes flattening a surface of the solid electrolyte loaded, and the step of loading the positive electrode active material includes flattening a surface of the positive electrode active material loaded.

The second aspect of the present invention allows the positive electrode active material to more effectively cover the solid electrolyte, thereby making it further unlikely for particles of the solid electrolyte to rise and adhere to the inner surface of the mixer container. In addition, according to the second aspect, the mixing can be smoothly performed.

A third aspect of the present invention is an embodiment of the first or second aspect. In the method according to the third aspect, the mixer container comprises a mixing tool with which the solid electrolyte and the positive electrode active material are mixed, the step of mixing the solid electrolyte and the positive electrode active material sequentially includes a first energy period in which an amount of energy per unit time supplied to the mixing tool is set to a first energy amount, and a second energy period in which an amount of energy per unit time supplied to the mixing tool is set to a second energy amount, and the first energy amount is smaller than the second energy amount.

According to the third aspect of the present invention, the mixing is gently performed in an early stage of the mixing step making it unlikely for particles of the solid electrolyte to rise, and thereafter, the energy amount is increased, thereby completing the mixing within a short time.

A fourth aspect of the present invention is directed to a manufacturing apparatus for use in the method for manufacturing a positive electrode for a non-aqueous secondary battery according to any one of the first to third aspects.

The manufacturing apparatus includes a plurality of the mixer containers that are dividable in a vertical direction in an installed state. Among the plurality of the mixer containers, a lowermost mixer container in the installed state has a capacity capable of accommodating the solid electrolyte and the positive electrode active material.

According to the fourth aspect of the present invention, when the solid electrolyte and the positive electrode active material are loaded, a movement amount in which the solid electrolyte and the positive electrode active material vertically move in the mixer container is reduced, thereby making it possible to inhibit particles of the solid electrolyte from rising during the loading.

### BRIEF DESCRIPTION OF THE DRAWINGS

FIG. 1 is a flowchart illustrating steps included in a method for manufacturing a positive electrode for a non-aqueous secondary battery, according to an embodiment of the present invention;

FIG. 2 is a diagram schematically illustrating a manufacturing apparatus according to an embodiment of the present invention; and

FIG. 3 is a perspective view of a main part of a mixer container according to the embodiment of the present invention.

### DETAILED DESCRIPTION OF THE INVENTION

### Positive Electrode for Non-Aqueous Secondary Battery

A positive electrode for a non-aqueous secondary battery according to an embodiment of the present invention includes a positive electrode current collector and a positive electrode active material layer formed on the positive electrode current collector and containing a positive electrode active material. The positive electrode for a non-aqueous secondary battery according to the present embodiment is for use as a positive electrode of a non-aqueous secondary battery. Examples of the non-aqueous secondary battery include, but are not limited to, a lithium ion secondary battery and a lithium metal battery.

As the positive electrode current collector, aluminum, nickel, stainless steel, or the like can be used, for example.

The positive electrode active material layer contains at least a positive electrode active material and a solid electrolyte. In addition to the forgoing, the positive electrode active material layer may contain a conductive auxiliary agent, a binder, and the like. As will be described later, the positive electrode active material layer is formed by applying, to the positive electrode current collector, a positive electrode mixture that is prepared by mixing the materials described above.

As the positive electrode active material, a substance known as a positive electrode active material for a non-aqueous secondary battery can be used. Examples of the positive electrode active material include: ternary positive electrode materials such as LiCoO₂, LiNiO₂, and NCM (Li(NiₓCo_{y}Mn_{z})O₂ (wherein 0<x<1, 0<y<1, 0<z<1, x+y+z=1); layered positive electrode active material particles such as LiVO₂and LiCrO₂; spinel positive electrode active materials such as LiMn₂O₄, Li(Ni_{0.25}Mn_{0.75})₂O₄, LiCoMnO₄, and Li₂NiMn₃O₈; and olivine positive electrode active materials such as LiCoPO₄, LiMnPO₄, and LiFePO₄.

The physical properties of the positive electrode active material are that it has the form of particles or powder with a wet or viscous surface. Accordingly, the positive electrode active material has a property of being less likely to be scattered during mixing of the materials, in comparison with the solid electrolyte, which will be described later.

The positive electrode active material is contained in the positive electrode active material layer in an amount of 60 to 90% by mass.

The solid electrolyte, when contained in the positive electrode active material layer, increases ion paths between particles of the positive electrode active material and improves the ion conductivity of the positive electrode active material layer. As the solid electrolyte, a solid electrolyte known to be used as a battery material can be used. Examples of the solid electrolyte include sulfide solid electrolytes, oxide solid electrolytes, nitride solid electrolytes, halide solid electrolytes, and the like.

The physical properties of the solid electrolyte are that it has the form of particles or powder with a particle diameter (D50) of about 5 μm to 0.1 μm. The particle diameter (D50) of the solid electrolyte is preferably less than 1 μm in order to form a composite with the positive electrode active material. The solid electrolyte has a dry surface. Accordingly, the solid electrolyte has a property of being more likely to rise to be scattered during mixing of the materials, in comparison with the positive electrode active material.

The solid electrolyte is contained in the positive electrode active material layer in an amount of 10 to 40% by mass.

As the conductive auxiliary agent, a known material for use as an electrode material can be used, and examples thereof include, but are not limited to, natural graphite, artificial graphite, acetylene black, etc. One of the example materials may be used alone, or two or more of them may be used in combination.

As the binder, a known material for use as an electrode material can be used, and examples thereof include, but are not limited to, polyvinylidene fluoride (PVdF), polymethyl methacrylate (PMMA), polyisobutene (PIB), styrene butadiene rubber (SBR), polyethylene-vinyl acetate copolymer (PEVA), nitrile rubber (NBR), nitrile hydride rubber (HNBR), etc. One of the example materials may be used alone, or two or more of them may be used in combination.

### Method for Manufacturing Positive Electrode for Non-Aqueous Secondary Battery

A method for manufacturing a positive electrode for a non-aqueous secondary battery according to an embodiment of the present invention includes a step of preparing a positive electrode mixture by mixing materials constituting the positive electrode active material layer, and optionally, a solvent, and preferably includes a step of applying the positive electrode mixture to a positive electrode current collector.

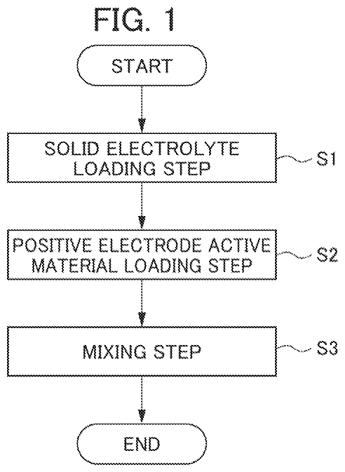

As illustrated in FIG. 1, the step of preparing the positive electrode mixture includes a solid electrolyte loading step S1, a positive electrode active material loading step S2, and a mixing step S3 in this order.

The solid electrolyte loading step S1 includes, for example, loading a solid electrolyte into a mixer container of a manufacturing apparatus, which will be described later. In the solid electrolyte loading step S1, it is preferable to gently load the solid electrolyte into the mixer container such that the solid electrolyte is not scattered.

The solid electrolyte loading step S1 preferably includes a solid electrolyte flattening step of flattening a surface of the loaded solid electrolyte using a spatula or the like. The flattening step allows for suppression of scattering of the solid electrolyte in the positive electrode active material loading step S2.

The positive electrode active material loading step S2 includes loading a positive electrode active material such that the positive electrode active material covers the solid electrolyte loaded in the solid electrolyte loading step S1. Performing the positive electrode active material loading step S2 after the solid electrolyte loading step S1 allows for suppression of scattering of the solid electrolyte in the mixing step S3. As a result, adhesion of scattered particles of the solid electrolyte to the inner surface of the mixer container is suppressed, thereby making it possible to prepare a positive electrode mixture having a mixing ratio substantially equal to the mixing ratio between the constituent materials as loaded. In the positive electrode active material loading step S2, it is preferable to gently load the positive electrode active material into the mixer container such that the solid electrolyte is not scattered.

In the positive electrode active material loading step S2, it is preferable to load the positive electrode active material such that the positive electrode active material covers substantially the entirety of the surface of the solid electrolyte loaded in the solid electrolyte loading step S1. Here, the surface of the solid electrolyte refers to a surface not in contact with the mixer container. Specifically, the positive electrode active material is loaded such that the positive electrode active material covers preferably 90% or more of the area of the surface of the solid electrolyte, and more preferably the entire surface of the solid electrolyte.

The positive electrode active material loading step S2 preferably includes a positive electrode active material flattening step of flattening a surface of the loaded positive electrode active material using a spatula or the like. The flattening step makes it possible to cover substantially the entire surface of the solid electrolyte with the positive electrode active material, thereby allowing for suppression of scattering of the solid electrolyte in the mixing step S3.

The mixing step S3 includes mixing the positive electrode active material and the solid electrolyte loaded in the mixer container by operating a mixing tool provided to the mixer container. For the mixing tool, an amount of energy (for example, a rotation rate, a torque) and mixing time can be arbitrarily changed by changing the settings of the apparatus.

The mixing step S3 preferably includes a first energy period in which an amount of energy per unit time that is supplied to the mixing tool is set to a first energy amount, and a second energy period in which an amount of energy per unit time that is supplied to the mixing tool is set to a second energy amount, in this order. Preferably, the first energy amount is smaller than the second energy amount. Specific examples of the first energy period and the second energy period will be described below.

The first energy period is provided for preliminary mixing the positive electrode active material and the solid electrolyte, and the first energy amount, which is the energy amount supplied in this period, is smaller than the second energy amount. Thus, the positive electrode active material and the solid electrolyte can be preliminarily mixed while scattering of the solid electrolyte is prevented or reduced.

The duration of the first energy period may be set to, for example, 3 to 20 minutes from the start of mixing, and the first energy amount may be set to 800 to 3000 rpm at a predetermined torque.

The second energy period is provided for completely mixing the positive electrode active material and the solid electrolyte, and the second energy amount, which is the energy amount supplied in this period, is greater than the first energy amount. Thus, mixing of the positive electrode active material and the solid electrolyte can be completed within a short time. The duration of the second energy period may be set to, for example, 30 to 90 minutes after the end of the first energy period, and the second energy amount may be set to 5000 to 12000 rpm at a predetermined torque.

Although it is simple and easy to set the first energy period and the second energy period as described above, the present invention is not limited to the above example. It is only necessary that a certain period in which a relatively small energy amount is supplied is followed by a certain period in which a relatively large energy amount is supplied. For example, a configuration is possible in which three or more stepwise periods are set such that the second energy period is followed by one or more periods in which further larger energy amount is supplied. Alternatively, a configuration is possible in which a myriad of very short periods including the first energy period and the second energy period are set such that the energy amount continuously increases.

In the case of mixing, with the positive electrode mixture, additional materials such as a conductive auxiliary agent, a binder, a solvent, and the like, in addition to the positive electrode active material and the solid electrolyte, the additional materials may be loaded into the mixer container after the positive electrode active material loading step S2 and mixed.

### Manufacturing Apparatus

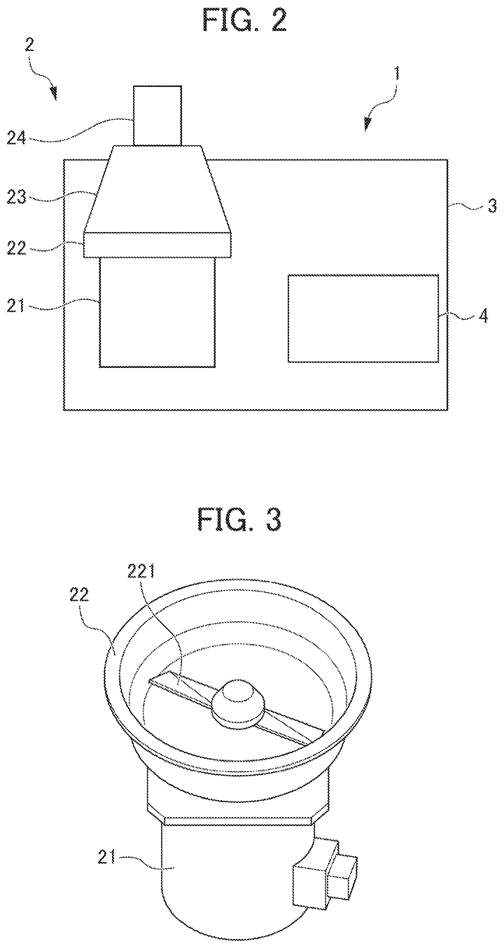

As illustrated in FIG. 2, a manufacturing apparatus 1 for use in the method for manufacturing a positive electrode for a non-aqueous secondary battery according to the present embodiment includes a mixer 2, a housing 3, and an operation part 4. The manufacturing apparatus 1 may be disposed in a glovebox.

The mixer 2 includes a body 21, a mixer containers 22 and 23, and a ventilation filter 24.

The body 21 houses a drive source (for example, a motor) for driving a stirring blade 221 as a mixing tool provided in the mixer container 22. The drive source is externally supplied with power via the housing 3.

The mixer containers 22 and 23 are a plurality of mixer containers that can be divided in the vertical direction in an installed state in which the manufacturing apparatus 1 is installed. As illustrated in FIG. 3, the mixer container 22 is the lowermost mixer container in the installed state, has a predetermined capacity, and is provided with the stirring blade 221 that is rotatably disposed on the bottom surface of the mixer container 22.

Preferably, the mixer container 22 has a capacity capable of accommodating the total amount of the solid electrolyte that is loaded in the solid electrolyte loading step S1 and the positive electrode active material that is loaded in the positive electrode active material loading step S2. The height of the mixer container 22 is preferably smaller than the width of the bottom surface of the mixer container 22. The height of the mixer container 22 may be equal to or less than half the width of the bottom surface of the mixer container 22. Using the mixer container 22 having the above-described configuration improves the workability of loading the solid electrolyte and the positive electrode active material into the mixer container 22 in the solid electrolyte loading step S1 and the positive electrode active material loading step S2, and can reduce a vertical distance by which the materials are moved, whereby particles of the solid electrolyte can be prevented or inhibited from rising to be scattered and adhering to the inner surface of the container.

The mixer container 23 has a certain volume therein, and is used as a lid of the mixer container 22 in the present embodiment. The present embodiment includes the two mixer containers 22 and 23, but this is a non-limiting example. Three or more mixer containers that can be divided in the vertical direction may be used.

The housing 3 includes a power source connected to the drive source housed in the body 21, and a controller. The controller includes, for example, a processor such as a CPU, a storage device such as a ROM or a RAM, and an input/output interface. The processor or the storage device stores a program enabling setting of the energy amount such as a rotation rate of the stirring blade 221 and a rotation time. Based on the program, the controller controls energy amounts to be supplied to the drive source and the stirring blade 221. The input/output interface is connected to an input/output means of the operation part 4 via a bus or the like.

The operation part 4 includes a touch panel, a button, a speaker, and the like, and is capable of receiving an input by a user of the manufacturing apparatus 1. The operation part 4 is capable of outputting, to a display such as the touch panel, various kinds of information including the energy amount such as the rotation rate of the stirring blade 221 and the rotation time, which are set by the user of the manufacturing apparatus 1. The operation part 4 may be capable of issuing an alarm sound via the speaker.

It should be noted that the preferred embodiment described above is not intended to limit the present invention, and modifications and improvements within the range in which the object of the present invention can be achieved are encompassed in the present invention.

### EXPLANATION OF REFERENCE NUMERALS

S1: Solid electrolyte loading step

S2: Positive electrode active material loading step

S3: Mixing step

1: Manufacturing apparatus

2: Mixer

22, 23: Mixer container

What is claimed is:

1. A method for manufacturing a positive electrode for a non-aqueous secondary battery, the method comprising successive steps of:
loading a solid electrolyte into a mixer container;
loading a positive electrode active material such that the positive electrode active material covers the solid electrolyte loaded in the step of loading the solid electrolyte; and
mixing the solid electrolyte and the positive electrode active material.

2. The method for manufacturing a positive electrode for a non-aqueous secondary battery according to claim 1, wherein
the step of loading the solid electrolyte includes flattening a surface of the solid electrolyte loaded, and
the step of loading the positive electrode active material includes flattening a surface of the positive electrode active material loaded.

3. The method for manufacturing a positive electrode for a non-aqueous secondary battery according to claim 1, wherein
the mixer container comprises a mixing tool with which the solid electrolyte and the positive electrode active material are mixed,
the step of mixing the solid electrolyte and the positive electrode active material sequentially includes a first energy period in which an amount of energy per unit time that is supplied to the mixing tool is set to a first energy amount, and a second energy period in which an amount of energy per unit time that is supplied to the mixing tool is set to a second energy amount, and
the first energy amount is smaller than the second energy amount.

4. A manufacturing apparatus for use in the method for manufacturing a positive electrode for a non-aqueous secondary battery according to claim 1, the manufacturing apparatus comprising:
a plurality of the mixer containers that are dividable in a vertical direction in an installed state; wherein
among the plurality of the mixer containers, a lowermost mixer container in the installed state has a capacity capable of accommodating the solid electrolyte and the positive electrode active material.
